(19) United States
(12) Patent Application Publication
(10) Pub. No.: US 2025/0378332 A1
(43) Pub. Date: Dec. 11, 2025

(54) METHOD AND DEVICE FOR REDUCING A NETWORK DIMENSION OF A BASE MODEL

(71) Applicant: Robert Bosch GmbH, Stuttgart (DE)

(72) Inventors: Arber Zela, Weil am Rhein (DE); Benedikt Sebastian Staffler, Tuebingen (DE); Frank Hutter, Freiburg Im Breisgau (DE); Martin Rapp, Esslingen Am Neckar (DE); Rhea Sukthanker, Freiburg Im Breisgau (DE)

(21) Appl. No.: 19/212,040

(22) Filed: May 19, 2025

(30) Foreign Application Priority Data
May 29, 2024 (DE) 10 2024 205 001.6

(51) Int. Cl. G06N 3/082; G06N 3/0464

(52) U.S. Cl. CPC G06N 3/082; G06N 3/0464

(57) ABSTRACT

A method for reducing a network dimension of a base model. The method including: providing the base model, which has pre-trained weight matrices and is trained to solve a target task; converting the base model into a one-shot model which has weight matrices; adding at least one, in particular network dimension-specific, low-rank matrix to each weight matrix of the one-shot model; carrying out a neural network search for the one-shot model to extract at least one submodel of the one-shot model having a reduced network dimension on the basis of the low-rank matrices and the weight matrices of the one-shot model until a termination criterion is reached; and providing the at least one submodel having a reduced network dimension, in particular for implementation on an embedded system.

### FIELD

The present invention relates to a method and a device for reducing a network dimension of a base model.

### BACKGROUND INFORMATION

In the field of artificial intelligence, research is faced with the challenge of making growing models efficient in order both to conserve computing resources and to allow applicability to embedded systems. The compression of large models plays a crucial role in this by allowing extensive networks to be used on devices which have limited resources and at the same time ensuring fast inferences. A prominent method in this field is structural pruning, which aims to remove redundant parts of a network such as entire layers or feature maps. This leads to significantly smaller and more efficient models.

Neural architecture search (NAS), in particular one-shot NAS, represents an extended form of structural pruning in which efficient architectures can be identified by traversing the search space once. Approaches such as BigNAS implement this search by using randomly initialized weights, while others, such as progressive shrinking in OFA (once-for-all), use already pre-trained weights effectively. These techniques provide insights into the scalability and adaptability of network architectures.

In parallel with these, the technique of low-rank approximation (LoRA) has attracted considerable interest, in particular in the context of fine-tuning foundation models (base models). LoRA aims to increase the efficiency of the fine-tuning by adding a low-rank decomposition to the existing weights, which significantly reduces the number of parameters and thus saves memory and computation time. Recently, the integration of LORA into model compression has been explored, wherein unstructured pruning is used to sparsify weights, followed by a NAS-based search for the optimal rank of low-rank adapters. This innovative combination, known as LoNAS, allows flexible adaptation of the network structure and opens up new dimensions in the architecture of models that go beyond conventional approaches.

Against this technical background, it is an object of the present invention to provide an improved method and/or an improved device for compressing a machine learning model.

The object may be achieved by a method according to certain features of the present invention. The object is also achieved by a device according to certain features of the present invention.

### SUMMARY

According to a first aspect of the present invention, a method for reducing a network dimension of a base model is provided. According to an example embodiment of the present invention, the method includes the following steps:
providing the base model, which has pre-trained weight matrices and is trained to solve a target task;
converting the base model into a one-shot model which has weight matrices;
adding at least one, in particular network dimension-specific, low-rank matrix to each weight matrix of the one-shot model;
carrying out a neural network search (NAS) for the one-shot model to extract at least one submodel of the one-shot model having a reduced network dimension on the basis of the low-rank matrices and the weight matrices of the one-shot model until a termination criterion is reached; and
providing the at least one submodel having a reduced network dimension, in particular for implementation on an embedded system.

It is understood that the steps according to the present invention as well as other optional steps do not necessarily have to be executed in the order shown, but can also be executed in a different order. Other intermediate steps can also be provided. The individual steps can also comprise one or more sub-steps without departing from the scope of the method according to the present invention.

According to a second aspect of the present invention, a device for reducing a network dimension of a base model is provide. According to an example embodiment of the present invention, the device includes an evaluation and computing unit that is designed to execute the following steps:
providing the base model, which has pre-trained weight matrices and is trained to solve a target task;
converting the base model into a one-shot model which has weight matrices;
adding at least one, in particular network dimension-specific, low-rank matrix to each weight matrix of the one-shot model;
carrying out a neural network search (NAS) for the one-shot model to extract at least one submodel of the one-shot model having a reduced network dimension on the basis of the low-rank matrices and the weight matrices of the one-shot model until a termination criterion is reached; and
providing the at least one submodel having a reduced network dimension, in particular for implementation on an embedded system.

The explanations given for the method of the present invention apply accordingly to the device of the present invention. It is understood that linguistic modifications of features formulated for the method can be reformulated for the device in accordance with standard linguistic practice, without such formulations having to be explicitly listed here.

According to an example embodiment of the present invention, adding the at least one low-rank matrix to each weight matrix of the one-shot model comprises, in the simplest case, adding a LoRA matrix that is not network dimension-specific. For example, if a network has a linear layer having multiple possible output channels, a LoRA matrix can be added that is divided for all possible output channels of the linear layer. The division is preferably done by slicing. More complex versions of LoRA matrices can comprise adding multiple LoRA matrices, either one or any number per network configuration, wherein the combination can be carried out by using a router.

In the present case, it is provided to combine one-shot NAS with LoRA for structural pruning. This combination requires a technical adaptation, which the inventors have recognized in the present case. Specifically, low-rank weighting matrices are added to the model parameters, e.g., for all linear layers, in a foundation model or a base network. The low-rank weight matrices are used for smaller versions of the base architectures. Only the low-rank matrices are then trained during the NAS method.

The pre-trained weights, however, are fixed. The present method represents a novel algorithm for one-shot searching for neural architectures that uses low-rank weighting matrices to efficiently find smaller versions of a basic network (foundation model) in terms of computational power and memory consumption.

‘One-shot neural architecture search (NAS)’ describes a method in which a single large machine learning model is trained in such a way that submodels can be extracted from the large machine learning model. This can be done, for example, by removing channels and/or layers and/or neurons from the large machine learning model and/or its network structure. In the case of transformer-based networks, smaller architectures can, for example, have a smaller embedding dimension, a modified MLP ratio, a reduced number of heads, and/or a reduced network depth. The MLP ratio preferably describes the ratio of the dimension of the inputs and outputs to the ratio of the hidden layers in the MLP. In the standard transformer, the MLP preferably has exactly one hidden layer. MLPs are a form of fully connected layers (or density layers) found in many types of artificial neural networks.

How the weights of the base model are pre-trained is basically arbitrary. The pre-training method can be, for example, supervised, semi-supervised or unsupervised. The basic goal is to find at least a smaller or compressed version of the base model.

Carrying out the neural architecture search (NAS) can be understood as a training method until the termination criterion is reached. The termination criterion can have multiple termination criteria. The termination criterion can have a threshold value when the network architecture of the at least one submodel is optimized in terms of solving the target task.

Furthermore, a hardware metric can also be included in the NAS algorithm for the termination criterion, which hardware metric makes it possible to search for optimal architectures of submodels with regard to target hardware. This can be done in addition to the optimization of the network architecture in terms of solving the target task.

The aim of NAS is to find network architectures that perform sufficiently ‘well’ for a specific target task. The target task can be, for example, in the field of classification and/or object recognition and/or semantic segmentation. The termination criterion can have, for example, a predetermined classification accuracy and/or a predetermined accuracy in object recognition and/or a predetermined accuracy in semantic segmentation. Furthermore, there can be additional objectives for the search method for the at least one submodel, which additional objectives can include both efficiency on the target hardware, such as latency or energy consumption, and hardware-independent objectives, such as the number of parameters and FLOPs, of an architecture. In the present case, one-shot NAS is used as the NAS method. First, the provided base model is converted into a one-shot model. This means that the base model is given the ability to extract submodels from the base model that, for example, have fewer channels or fewer layers or architectural dimensions generally. The architectural dimensions are searched during the NAS process.

The present method and device of the present invention have the advantages that they are based on pre-trained weights and thus save computational effort. Furthermore, the complete weights do not have to be fine-tuned, resulting in faster fine-tuning and lower memory requirements for NAS. The present method and the corresponding device also obtain many more searchable dimensions than previous approaches. Overall, the present method and the corresponding device are computationally more efficient than previous approaches.

In the present case, the provided base model is converted into a one-shot model as described above. Next, on the basis of the LoRa approach, low-rank matrices are added for all weight matrices in the one-shot model that describe architectural dimensions on the basis of which submodels are searched. For example, all linear layers in a transformer, in particular including the embedding, MLP, and MHSA layers, are each described by a low-rank matrix. There are multiple possible ways of including the low-rank matrices. Firstly, a single low-rank matrix can be added for each weight of the one-shot model, wherein preferably weight interleaving is used to extract smaller versions of the corresponding weight matrix. Alternatively, multiple low-rank matrices can be added for each weight of the base model for each possible choice in the architectural dimension of the corresponding layer. For example, if a layer has five different possible choices for the number of output layers, a low-rank matrix can be added for each of the individual possible choices.

LoRA introduces low-rank decompositions for matrices in a base model. Given a weight matrix W∈R^{d×k}, a low-rank matrix of the form B*A, where * denotes matrix multiplication, and A∈R^{r×k}, B∈R^{d×r}, where r<min<(d,k). In this way, the product of B * A has the same dimension as W, and they can be added during inference to give W_{new}=W+B*A. In this case * can also be an element-wise product. While training or finding the submodels, W is preferably kept fixed or remains unchanged, and only A and B are trained.

The use of low-rank matrices is used to scale the original weights of the base model.

The present method and the corresponding device can be used for machine learning models that are used together with image data originating, for example, from a video camera and/or a radar sensor and/or a lidar sensor and/or an ultrasonic sensor and/or a motion sensor and/or a thermal sensor. The present method and the corresponding device can be used for machine learning models that work with audio data and/or text data. On the basis of the sensor signal, information about the elements encoded by the sensor signal can be obtained, i.e., an indirect measurement can be carried out on the basis of the sensor signal used as a direct measurement.

The present invention provides an advanced method based on the analysis and processing of sensor data by means of artificial intelligence, specifically by using neural networks. The method and device are capable of executing a wide range of functions that can be used in various applications to improve efficiency and security in technical and non-technical environments. The present invention can help to classify sensor data in an efficient and computationally conservative manner, to detect objects within these data, and/or to execute semantic segmentation. This is particularly useful for applications in the traffic sector, where, for example, the detecting and classifying traffic signs, road surfaces, pedestrians and vehicles is required. By means of the present computationally optimized analysis of low-level features such as edges or pixel attributes in images, the system allows precise and reliable processing of visual data while simultaneously reducing memory and computing requirements. A further important aspect of the present invention is the provision of computing-and memory-optimized machine learning models that can be used to carry out regression analyses by using video and audio analysis. Such a machine learning model system can determine continuous values, such as the distance, speed or acceleration of objects. These functions are important for autonomous driving and other applications in which accurate measurement of dynamic variables is required. The technology also allows tracking of specific elements or objects in the data on the basis of the same low-level features. This is essential for security and surveillance systems as well as for interactive applications where continuous object tracking is required. The present invention can help to detect anomalies in technical systems in a computationally optimized manner. By optimizing neural network architectures, the system is capable of being used in various fields, in particular where advanced pattern recognition and data analysis are required. Finally, the present invention can also be used to control technical systems. It is capable of calculating and implementing control signals to control various systems, from robotic systems and vehicles to household appliances and medical imaging systems. This is done by measuring and analyzing data, typically from sensors, and then adapting and controlling the technical system according to the findings obtained.

In a further aspect of the present invention, it is provided that the base model has a CNN or a transformer. In general, the technology is also applicable to other models such as recurrent networks (like LSTMs).

Convolutional neural networks (CNNs) are specialized in processing data which has a known, grid-like topology. Examples of such data are images (2D grids of pixels) and audio signals (1D grids of samples). A CNN uses a mathematical operation called ‘convolution’ to extract features from these data. The convolutional layer in a CNN preferably uses filters that slide over the input image (or other type of input signal) to identify features such as edges, corners, and other texture-based information. This filtered information is then processed by further layers, which typically consist of pooling layers (to reduce dimensionality), further convolutional layers, and finally fully connected layers. Transformers are a class of models based on a mechanism called ‘self-attention,’ which allows each piece of data to relate to every other piece. Unlike CNNs, which process spatial hierarchies of features, transformers can identify dependencies across long distances in the data. Transformers do not have a recurrent structure (like LSTMs, for example) and process all inputs simultaneously, which makes them particularly well-suited for parallel processing. They consist of multiple layers of attention blocks and feedforward neural networks.

In a further aspect of the present invention, extracting the at least one submodel comprises reducing a number of network channels and/or network layers and/or a number of neurons per network layer and/or a number of embedding dimensions and/or a kernel size and/or a number of attention heads and/or an MLP ratio and/or a network depth by masking weight matrices of the one-shot model by the respective low-rank matrices.

It is also provided according to an example embodiment of the present invention to use low-rank matrices to predict a mask of the desired dimensionality for the pre-trained weights W and to extract a subset of the weights W. That is, the low-rank matrix B*A is preferably used to extract parts of the matrix W and to mask other parts of the matrix W. The mask can either be a binary mask for W or directly predict positions of the entries of W to be extracted.

In a further aspect of the present invention, it is provided that the masking comprises applying Gumbel Softmax and/or ReinMax and/or a bilinear interpolation from deformable convolutions.

To ensure the differentiability of the masking process, techniques such as Gumbel Softmax, ReinMax, and bilinear interpolation from deformable convolutions can be used when the index positions are directly predicted. This can be combined with the LoRA modules used to scale or offset the extracted weights as described above.

In a further aspect of the present invention, extracting at least one submodel comprises interleaving weights of the at least one submodel of the one-shot model by extracting the weights of the at least one submodel from weights of the one-shot model by pruning.

The weights of the submodels of the one-shot model are interleaved by extracting the weights of the submodels from the weights of the one-shot model by pruning. For example, if the one-shot model has a linear layer which has a weight matrix W∈R^{d×d}, a smaller version of it is extracted by considering only the first dimensions, e.g., for a smaller input dᵢₙ and a smaller output feature dimension dₒᵤₜ, the weight matrix W[: dᵢₙ,: dₒᵤₜ] is used, wherein the notation can preferably refer to array slicing as in Numpy code.

In a further aspect of the present invention, adding the at least one, in particular network dimension-specific, low-rank matrix to each weight matrix of the one-shot model comprises adding multiple low-rank matrices for each weight and applying a routing mechanism, in particular mixture-of-experts (MoE), in order in this way to select a weight combination of the low-rank matrices on the basis of a sample network architecture configuration.

For example, if a layer that has three options for the number of output channels is considered, preferably three LoRA weight matrices would be added, one for each possible option of the output channel. During training, the LoRA matrix that matches the current number of output channels of the corresponding layer is then used. An architecture dimension is therefore preferably assigned statically to the LoRA matrix used and not dynamically by the router.

Furthermore, according to an example embodiment of the present invention, multiple low-rank matrices can be added for each weight. A routing mechanism such as mixture-of-experts (MoE), which routing mechanism selects a weight combination of the low-rank matrices on the basis of a sample architectural configuration, can be used for this. Similarly to MOE, routing can take different forms, such as top-k routing or soft mixing.

In a further aspect of the present invention, the weight matrices of the one-shot model are kept fixed during the NAS, and weights of the low-rank matrices are adjusted and/or trained until the termination criterion is reached.

During one-shot model training, according to an example embodiment of the present invention, the weights of the base model are preferably frozen, and only the LoRa weights are trained. The NAS method can be like other one-shot NAS algorithms. A two-stage NAS can be used, wherein first the weights of the one-shot model are trained by sampling individual architectures from the one-shot model, e.g. by sampling a single random architecture as in SPOS or multiple architectures, e.g. on the basis of the sandwich rule. Furthermore, differentiable approaches such as DARTS or the use of the MODNAS training strategy are possible.

In a further aspect of the present invention, a control unit, in particular designed as an embedded system, is also provided, which is included in a vehicle having an autonomous driving function and/or a robotic system and/or an industrial machine and on which the provided submodel having a reduced network dimension can be executed in an optimized manner in terms of computing power and memory space.

The method can be used in machine learning models in the field of autonomous driving. For example, it must be ensured that an automated vehicle does not collide with pedestrians. On the basis of the semantic segmentation, a computer calculates depth information of all pedestrians, calculates a trajectory around these pedestrians and controls the vehicle such that it follows this trajectory so closely that it does not hit any pedestrians. This applies to any mobile robot in order to avoid people who might get in its way.

In a further aspect of the present invention, a computer program having program code is provided for executing at least parts of the present method in one of its aspects when the computer program is executed on a computer. In other words, a computer program (product) comprising instructions which, when the program is executed by a computer, cause the computer to execute the method/the steps of the method in one of its aspects.

In a further aspect of the present invention, a computer-readable medium having program code of a computer program is proposed for executing at least parts of the method of the present invention in one of its aspects when the computer program is executed on a computer. In other words, the present invention relates to a computer-readable (memory) medium comprising instructions which, when executed by a computer, cause the computer to execute the method/the steps of the method of the present invention in one of its aspects.

The described embodiments and developments of the present invention can be combined with one another as desired.

Further possible embodiments, developments and implementations of the present invention also include combinations not explicitly mentioned of features of the present invention described above or in the following relating to the exemplary embodiments.

### BRIEF DESCRIPTION OF THE DRAWINGS

The figures are intended to impart further understanding of the embodiments of the present invention. They illustrate embodiments and, in connection with the description, serve to explain principles and concepts of the present invention.

Other embodiments and many of the mentioned advantages are apparent from the figures. The illustrated elements of the figures are not necessarily shown to scale relative to one another.

FIG. 1 shows a schematic flow chart of an exemplary embodiment of the method of the present invention.

FIG. 2 shows a example schematic representation of a layer of a network to which the method of the present invention is applied.

In the figures of the figures, identical reference signs denote identical or functionally identical elements, parts or components, unless stated otherwise.

### DETAILED DESCRIPTION OF EXAMPLE EMBODIMENTS

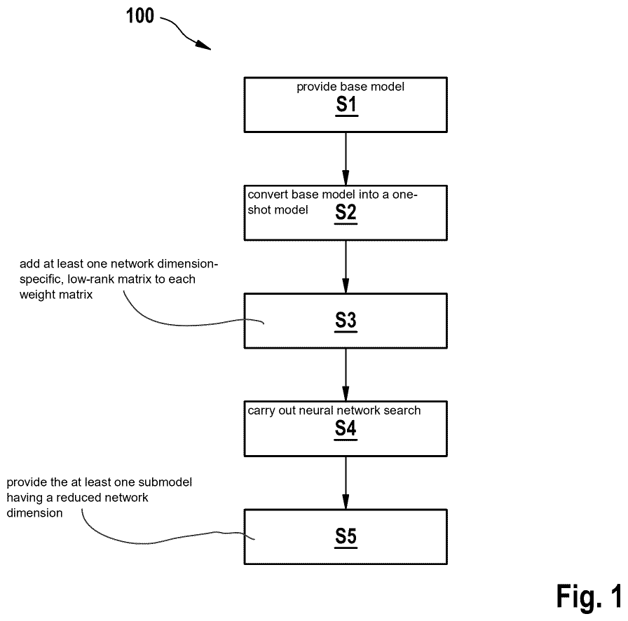

FIG. 1 shows a schematic flow chart of a method for reducing a network dimension of a base model.

In any embodiment, the method can be executed, at least in part, by a device 100, which for this purpose can comprise multiple components not shown in more detail, for example one or more provisioning units and/or at least one evaluation and computing unit. It is self-evident that the provisioning unit can be designed together with the evaluating and computing unit or can be different therefrom. Furthermore, the device 100, which can be part of a system, can comprise a storage unit and/or an output unit and/or a display unit and/or an input unit.

The computer-implemented method comprises at least the following steps:
In a step S1, the base model is provided, which has pre-trained weight matrices and is trained to solve a target task.
In step S2, the base model is converted into a one-shot model which has weight matrices.
In a step S3, at least one, in particular network dimension-specific, low-rank matrix is added to each weight matrix of the one-shot model.
In a step S4, a neural network search (NAS) is carried out for the one-shot model to extract at least one submodel of the one-shot model having a reduced network dimension on the basis of the low-rank matrices and the weight matrices of the one-shot model until a termination criterion is reached.
In a step S5, the at least one submodel having a reduced network dimension is provided, in particular for implementation on an embedded system.

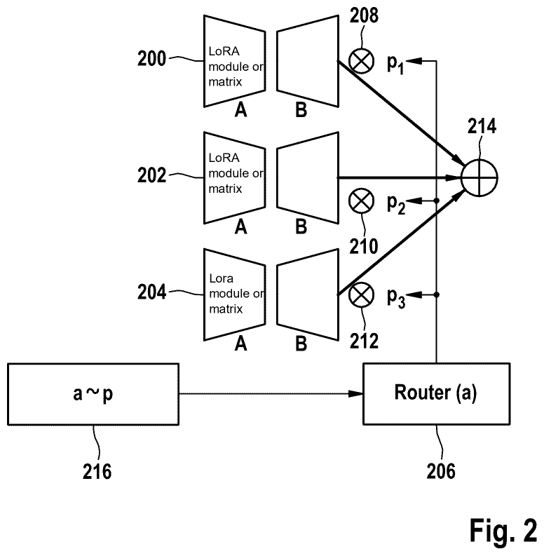

FIG. 2 shows a network layer of a base model or a one-shot model derived therefrom. More specifically, FIG. 2 shows a routing-based combination of multiple LoRA modules or LoRA matrices 200, 202, 204. The respective LoRa modules preferably represent different network dimensions of the base model. A router (a) 206 learns which of the LoRa modules should be given greater weight when reducing a certain network dimension, which is indicated by the weights p1, p2, p3 or 208, 210, 212. This then results in an additively ascertained LoRa matrix 214, which can fail depending on the input 216 into the router 206. The router 206 obtains as input a network dimension to be reduced in the search space of the NAS.

1-10. (canceled)

11. A method for reducing a network dimension of a base model, the method comprising the following steps:
providing the base model, which has pre-trained weight matrices and is trained to solve a target task;
converting the base model into a one-shot model which has weight matrices;
adding at least one respective network dimension-specific, low-rank matrix to each weight matrix of the one-shot model;
carrying out a neural network search for the one-shot model to extract at least one submodel of the one-shot model having a reduced network dimension based on the low-rank matrices and the weight matrices of the one-shot model until a termination criterion is reached; and
providing the at least one submodel having a reduced network dimension, for implementation on an embedded system.

12. The method according to claim 11, wherein the base model has a CNN or a transformer.

13. The method according to claim 11, wherein the extracting of the at least one submodel includes reducing a number of network channels and/or network layers and/or a number of neurons per network layer and/or a number of embedding dimensions and/or a kernel size and/or a number of attention heads and/or an MLP ratio and/or a network depth, by masking the weight matrices of the one-shot model by the respective low-rank matrices.

14. The method according to claim 13, wherein the masking includes applying Gumbel Softmax and/or ReinMax and/or a bilinear interpolation from deformable convolutions.

15. The method according to claim 11, wherein the extracting of the at least one submodel includes interleaving weights of the at least one submodel of the one-shot model by extracting the weights of the at least one submodel from weights of the one-shot model by pruning.

16. The method according to claim 11, wherein the adding of the at least one respective network dimension-specific, low-rank matrix to each weight matrix of the one-shot model includes adding multiple low-rank matrices for each weight and applying a routing mechanism including a mixture-of-experts (MoE), to select a weight combination of the low-rank matrices based on a sample network architecture configuration.

17. The method according to claim 11, wherein the weight matrices of the one-shot model are kept fixed during the NAS, and weights of the low-rank matrices are adjusted and/or trained until the termination criterion is reached.

18. A non-transitory computer-readable data carrier on which are stored program code of a computer program for reducing a network dimension of a base model, the computer program, when executed by a computer, causing the computer to perform the following steps:
providing the base model, which has pre-trained weight matrices and is trained to solve a target task;
converting the base model into a one-shot model which has weight matrices;
adding at least one respective network dimension-specific, low-rank matrix to each weight matrix of the one-shot model;
carrying out a neural network search for the one-shot model to extract at least one submodel of the one-shot model having a reduced network dimension based on the low-rank matrices and the weight matrices of the one-shot model until a termination criterion is reached; and
providing the at least one submodel having a reduced network dimension, for implementation on an embedded system.

19. A device for reducing a network dimension of a base model, wherein the device comprises an evaluation and computing unit, which is configured to execute the following steps:
providing the base model, which has pre-trained weight matrices and is trained to solve a target task;
converting the base model into a one-shot model which has weight matrices;
adding at least one network dimension-specific, low-rank matrix to each weight matrix of the one-shot model;
carrying out a neural network search for the one-shot model to extract at least one submodel of the one-shot model having a reduced network dimension based on the the low-rank matrices and the weight matrices of the one-shot model until a termination criterion is reached; and
providing the at least one submodel having a reduced network dimension, for implementation on an embedded system.
